(19) United States
(12) Patent Application Publication
(10) Pub. No.: US 2010/0200021 A1
(43) Pub. Date: Aug. 12, 2010

(54) Slide Conditioning Systems and Methods

(76) Inventors: Nils Adey, Salt Lake City, UT (US); Tom Moyer, Salt Lake City, UT (US); Dale Emery, Salt Lake City, UT (US); Michael Worthen, West Jordan, UT (US); Wanyuan Ao, Salt Lake City, UT (US)

Correspondence Address: THORPE NORTH & WESTERN, LLP., P.O. Box 1219, SANDY, UT, 84091-1219, US

(21) Appl. No.: 12/247,408

(22) Filed: Oct. 8, 2008

Related U.S. Application Data
(63) Continuation-in-part of application No. 11/707,567, filed on Feb. 15, 2007, now abandoned.
(60) Provisional application No. 60/774,875, filed on Feb. 17, 2006.

(51) Int. Cl. B08B 11/02

(52) U.S. Cl. 134/25.1; 134/146; 134/52

(57) ABSTRACT

A slide conditioning system comprises a basin, suitable to retain fluids therein, and a slide carrier having a bidirectional valve formed therein, the slide carrier adapted to carry a plurality of slides therein. A rotor arm is rotatable relative to the basin, the rotor arm being capable of carrying the slide carrier and applying centrifugal forces to the slide carrier as the rotor arm rotates. A fluidics system is also provided and a fluid coupling port is operable to selectively and fluidly mate with the bidirectional valve of the slide carrier while the slide carrier is carried by the rotor arm to fluidly couple the slide carrier to the fluidics system.

### PRIORITY CLAIM

This is a continuation-in-part of copending U.S. patent application Ser. No. 11/707,567, filed Feb. 15, 2007, which claims the benefit of U.S. Provisional Patent Application Ser. No. 60/774,875, filed Feb. 17, 2006, each of which is hereby incorporated herein by reference.

### FIELD OF THE INVENTION

The present invention relates generally to systems for use in conditioning slides. More particularly, the invention relates to systems for washing microarray slides.

### BACKGROUND OF THE INVENTION

Microarray hybridization is a well-known technique used in detecting whether a specific nucleic acid resides in a given sample. This technique generally includes the immobilization of known nucleic acid sequence probes on a glass slide, followed by introduction of the sample media to the probes in order to determine whether the sample contains any complementary nucleic acid sequence. When matching sequences are found, the presence of an indicator confirms the match.

Processing a hybridization slide for later analysis typically can require a significant number of process steps, including forming a reaction chamber around the portion of the slide containing the array of immobilized reactant probes, filling the reaction chamber with the mobile reactant specimens in solution, hybridizing the specimens with the probes during an incubation step, and washing away the un-hybridized fluid sample from the microarray slide upon completion of the incubation phase. Each of these phases should be completed without damaging the hybridized reactant samples.

While many technical challenges are presented by each of these phases, the washing phase in particular has proved problematic in past efforts. The washing phase should be completed in a thorough and efficient manner, cleaning all portions of the slide, including the side edges. However, washing processes to date have often proven at least partially ineffective or inefficient, particularly in areas of the slide that are held by or abut other structures.

### SUMMARY OF THE INVENTION

The present invention provides a slide conditioning system, including a basin, suitable to retain fluids therein and a slide carrier having a bidirectional valve formed therein. The slide carrier can be adapted to carry a plurality of slides therein. A rotor arm can be rotatable relative to the basin, the rotor arm being capable of carrying the slide carrier and applying centrifugal forces to the slide carrier as the rotor arm rotates. A fluidics system can also be provided, and a fluid coupling port can be operable to selectively and fluidly mate with the bidirectional valve of the slide carrier while the slide carrier is carried by the rotor arm to fluidly couple the slide carrier to the fluidics system.

In accordance with another aspect of the invention, a slide carrier for use in a slide conditioning system is provided. The slide carrier can include a series of walls forming an enclosure and a series of slots formed in at least one of the walls. The slots can be sized and shaped to receive a slide therein. A bidirectional valve can be operable to retain fluid within the carrier while subject to ambient conditions, and operable to allow fluid to flow from the carrier when the carrier is subject to centrifugal forces applied by slide conditioning system.

In accordance with another aspect of the invention, a method of conditioning of a plurality of slides is provided, including installing each of the plurality of slides into a slide carrier, the slide carrier having a bidirectional valve attached to or formed therein; coupling the slide carrier to a rotor arm of a slide conditioning system; engaging a fluid coupling port with the bidirectional valve of the slide carrier while the slide carrier is carried by the rotor arm; and introducing fluid into the slide carrier through the fluid coupling port.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a perspective view of a slide conditioning system in accordance with an embodiment of the invention;

FIG. 2 is a top view of the slide conditioning system of FIG. 1;

FIG. 3A is a perspective view of a slide carrier for use with the slide conditioning system of FIG. 1; and

FIG. 3B is a side, sectioned view of the slide carrier of FIG. 3A.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to “a slide” can include one or more of such slides.

### DEFINITIONS

In describing and claiming the present invention, the following terminology will be used in accordance with the definitions set forth below.

As used herein, the term “substantially” refers to the complete or nearly complete extent or degree of an action, characteristic, property, state, structure, item, or result. As an arbitrary example, an object that is “substantially” enclosed is an object that is either completely enclosed or nearly completely enclosed. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete, or nearly complete, lack of an action, characteristic, property, state, structure, item, or result. As an arbitrary example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

Relative directional terms such as “upwardly,” “downwardly” and/or “vertically” are sometimes used herein in order to describe the present invention in the most straightforward manner. It is to be understood that such terms are not intended to narrow the invention and should not be construed in any limiting manner.

### Invention

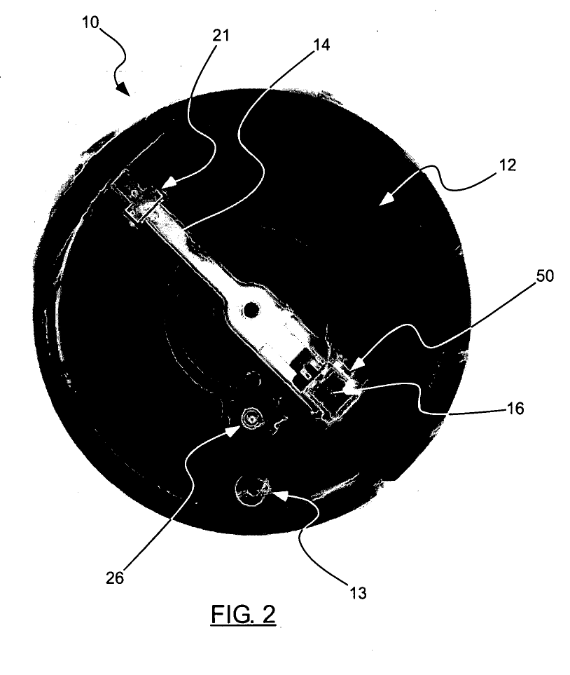

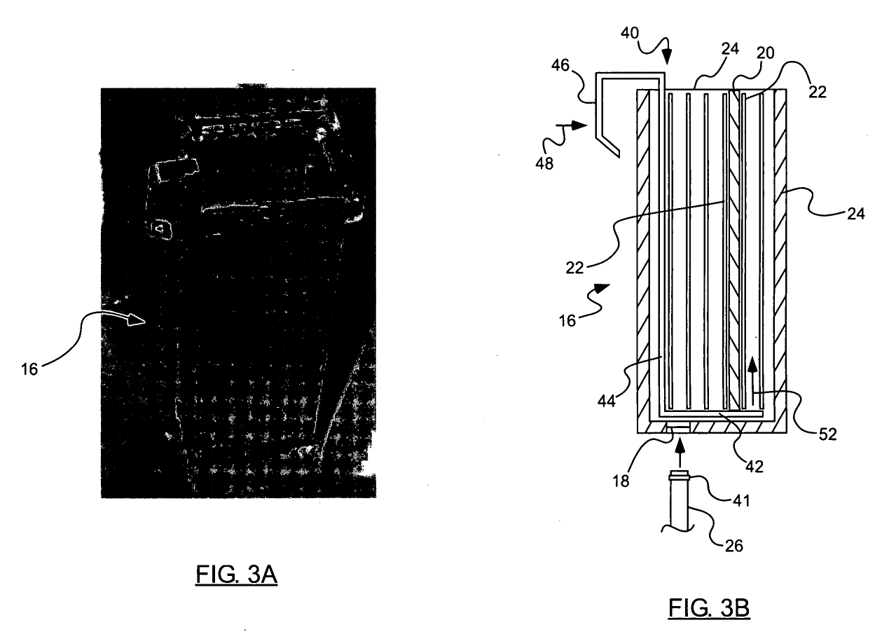

The present invention is generally directed to systems for use in conditioning slides. While not so required, the invention is well adapted for use in slide conditioning processes in which washing of microarray slides is necessary or beneficial. As shown generally in the figures, in accordance with one embodiment of the invention, a slide conditioning system 10 is provided that can include a basin 12 (shown in top view in FIG. 2) that is suitable to retain fluids therein. A rotor arm 14 (FIG. 2) can be provided that can be powered for rotation at high speeds by way motors, controllers, etc., that are well known to those of ordinary skill in the art. A slide carrier 16 (FIGS. 2, 3A and 3B) can include a bidirectional valve (18 in FIG. 3B) formed therein. The slide carrier is generally adapted to carry a plurality of slides, one of which is shown by example at 20 in FIG. 3B.

A fluidics systems, not shown in detail, can be provided to supply one or more fluids to the slide carrier to aid in washing or otherwise conditioning the slides within the slide carrier. Also not shown in detail are the various components of the system that provide power to, and control, the rotor arm (and thus facilitate centrifugation of the slide carrier). It is understood that one of ordinary skill in the art, having possession of this disclosure, could readily utilize known technology in these aspects of the invention.

The rotor arm 14 can include an adjustable counterweight 21 that can be adjusted according to a number of slides carried within the slide carrier. In the example shown, the slide carrier can be moved laterally relative to the rotor arm 14 to aid in balancing mass carried by each side of the rotor arm as it is spun to centrifugate the slide carrier. The basin 12 can include various features known to those of ordinary skill in the art, including drain 13 operable to selectively evacuate fluids contained by the basin after centrifuging.

Turning now to FIG. 3B, in a typical application, one or more slides 20 can be loaded into the slide carrier 16 and can be maintained in a spaced-apart relationship by way of a plurality of notch walls 22 formed in one or more sides 24 of the slide carrier. Once the desired number of slides has been loaded, a lid (not shown, as it is removed from FIGS. 3A and 3B) can optionally be placed upon the slide carrier and the slide carrier can be coupled to or attached to the rotor arm 14. As shown in FIG. 2, in one aspect, the slide carrier can be inserted between, or otherwise attached to, a pair of arms or similar structure formed on the rotor arm. Generally speaking, when attached to the rotor arm, the slide carrier will be at least somewhat limited from moving in both a vertical and a horizontal direction relative to the rotor arm.

Once secured to or within the rotor arm 14, the slide carrier 16 can be positioned above a fluid coupling port 26 which is generally disposed adjacent a bottom surface of the basin 12. The fluid coupling port can take a variety of forms: in the embodiment shown, it is a male fluidics coupling that is moveable relative to a floor of the basin. In this example, the fluid coupling port selectively extends upwardly and downwardly, as desired, to engage the slide carrier. The coupling is shown in FIG. 2 in a retracted position, such that the rotor arm 14 carrying the slide carrier 16 can freely rotate over the coupling port, without contacting the coupling port. Thus, when the coupling port is in the retracted position, the rotor arm is free to rotate and can be used to centrifugate the slide carrier at high speeds.

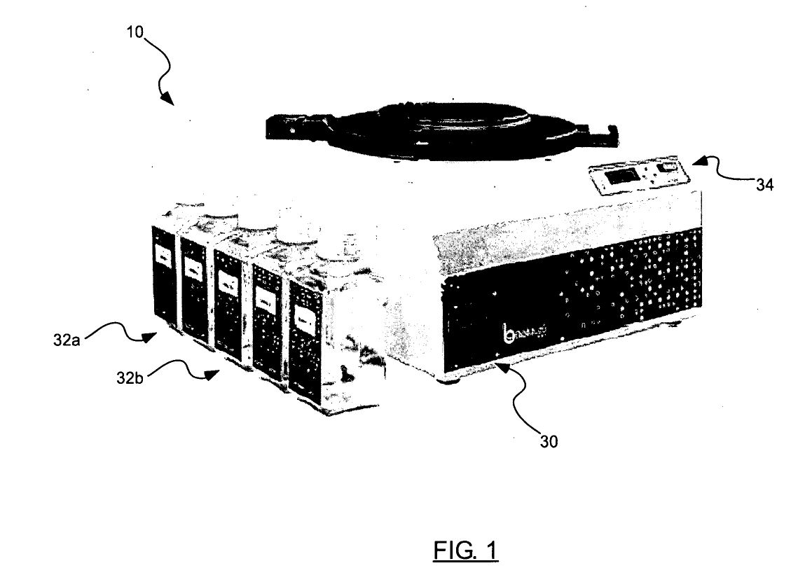

When desired, however, the fluid coupling port 26 can be extended upwardly (by activation, for example, of engagement lever 30 shown FIG. 1) in order to facilitate engagement of the port (and thus the fluidics system) within the slide carrier. In one typical application, the slide carrier 16 can be fluidly coupled to the fluidics system by first positioning the rotor arm 14 (which is carrying the slide carrier) over the fluid coupling port. Once in position over the coupling port, lever 30 can be activated causing the coupling port 26 to extend upwardly toward the slide carrier. As shown in FIG. 3B, the coupling port 26 can extend upwardly until engaged with valve 18. In this manner, the slide carrier can be placed into fluid communication with the general fluidics system without disengaging the slide carrier from the fluid coupling port. A seal 41 (e.g., an O-ring) can be carried by the fluid coupling port to facilitate fluid-tight engagement with the slide carrier.

While the coupling port 26 is shown in the figures as being moveable relative to the slide carrier 16, it is also contemplated that the slide carrier can be moveable vertically relative to the coupling port. For example, rather than moving the coupling port into engagement with the slide carrier, the system can be configured to move the slide carrier downward into engagement with the fluid coupling port.

Once the slide carrier is coupled to the fluidics systems, fluid (e.g., gas or liquid) can be introduced through the valve and into the slide carrier to wash or otherwise condition the slides carried therein. As shown in FIG. 1, the general fluidics system can include a plurality of reservoirs 32a, 32b, etc., that can each include common or different fluid types (the reservoirs shown are liquid reservoirs, however gas reservoirs can readily be incorporated into the fluidics system as well). A control panel 34 can provide an interface by which users or operators can select various pre-programmed conditioning sequences. The control panel can also allow users or operators to manually specify various conditioning parameters for a particular need. For example, volumetric rates and flow rates of the various fluids can be selected, as well as wash durations, soak durations, spin durations (e.g., centrifuge durations), spin velocities, etc.

The valve, 18 in FIG. 3B, can take a variety of forms. In one embodiment, the valve is operable to retain fluid within the carrier while subject to ambient conditions, and is operable to allow fluid to flow from the carrier when the carrier is subject to centrifugal forces applied by the slide conditioning system. One manner in which this can be accomplished is by providing the valve in the form of a polymeric septum having one or more slits formed therein. The valve in this example has been found to adequately retain fluid within the slide carrier when under atmospheric conditions (e.g., during handling when loading the carrier with slides, which can be accomplished with the slide carrier at least partially submerged beneath the fluid, or while transporting the slide carrier from a loading station to the slide conditioning system 10).

In addition to retaining fluid while under atmospheric conditions, the valve 20 will open when the slide carrier 16 is subjected to G-forces created during centrifuging of the slide carrier. This configuration is advantageous in that the valve need not be manually opened prior to centrifuging. The valve is also designed to be easily opened by the fluid coupling port 26 when the port is raised and inserted into or through the valve. The valve also seals itself when (or as) the coupling port is withdrawn from the valve.

As illustrated in FIG. 3B, in one aspect of the invention, the system can include an agitation bar 40. The agitation bar 40 can be operable to agitate the slides by moving the slides slightly within the notch walls 22 to thereby prevent materials from collecting in the spaces between the slides and the notch walls or the walls of the carrier. The agitation can also aid in preventing the creation of “dry spots” between the slides and the notch walls or walls of the slide carrier.

As shown in FIG. 3B, the agitation bar 40 can include a lower member 42 that can extend adjacent (or below) lower portions of slides 20 carried by the slide carrier 16. An extension member 44 can extend upwardly from the lower member and can extend beyond the limits of the slide carrier. An engagement member 46 can extend toward an actuator (shown at 50 in FIG. 2) that can be moveably coupled to the rotor arm. In this manner, movement of the engagement member (e.g., in the direction indicated at 48) by the actuator results in, or causes, the lower member to agitate slides carried by the slide carrier (e.g., to move the slides in the direction indicated at 52).

By thus configuring the agitation system, the actuator 50 can be moveable both while the rotor arm 14 is rotating, and while the rotor arm is stationary. In this manner, the slides can be agitated while either subject to a wash cycle (or other conditioning cycle), or while being dried during centrifugation.

In addition to the structural features discussed above, the present invention also provides a method of conditioning a plurality of slides, including installing each of the plurality of slides into a slide carrier, the slide carrier having a bidirectional valve attached to or formed therein. The slide carrier can be coupled to a rotor arm of a slide conditioning system. A fluid coupling port can be engaged with the bidirectional valve of the slide carrier while the slide carrier is carried by the rotor arm. Fluid can be introduced into the slide carrier through the fluid coupling port.

Installing each of the plurality of slides into the slide carrier can include installing each of the plurality of slides while the slide carrier is at least partially submerged in a liquid.

The method can further include releasing fluid from the slide carrier through the fluid coupling port, disengaging the fluid coupling port from the bidirectional valve, and centrifuging the slide carrier. A counterweight carried by the rotor arm can be adjusted according to a number of slides carried by the slide carrier.

The bidirectional valve can be re-engaged with the fluid coupling port to again introduce fluid into the slide carrier. Each of the steps of releasing, disengaging and centrifuging can be performed while the slide carrier remains attached to the rotor arm.

The slides carried within the slide carrier can be agitating within the slide carrier to move the slides relative to the slide carrier. The agitation can be accomplished with an agitation bar extend at least partially out of the slide carrier.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A slide conditioning system, comprising:
a basin, suitable to retain fluids therein;
a slide carrier having a bidirectional valve formed therein, the slide carrier adapted to carry a plurality of slides therein;
a rotor arm, rotatable relative to the basin, the rotor arm being capable of carrying the slide carrier and applying centrifugal forces to the slide carrier as the rotor arm rotates;
a fluidics system; and
a fluid coupling port, operable to selectively and fluidly mate with the bidirectional valve of the slide carrier while the slide carrier is carried by the rotor arm to fluidly couple the slide carrier to the fluidics system.

2. The system of claim 1, wherein the bidirectional valve comprises a septum.

3. The system of claim 1, wherein the fluid coupling port is moveable relative to the basin.

4. The system of claim 1, further comprising an agitation bar, disposed within the slide carrier and operable to agitate slides carried by the slide carrier.

5. The system of claim 4, wherein the agitation bar includes:
a lower member extending adjacent lower portions of slides carried by the slide carrier;
an extension member, extending upwardly from the lower member and out of the slide carrier; and
an engagement member, extending toward an actuator moveably coupled to the rotor arm;
wherein movement of the engagement member by the actuator causes the lower member to agitate slides carried by the slide carrier.

6. The system of claim 1, further comprising an adjustable counterweight, carried by the rotor arm.

7. A slide carrier for use in a slide conditioning system, the slide carrier comprising:
a series of walls forming an enclosure;
a series of slots formed in at least one of the walls, the slots sized and shaped to receive a slide therein;
a bidirectional valve, operable to retain fluid within the carrier while subject to ambient conditions, and operable to allow fluid to flow from the carrier when the carrier is subject to centrifugal forces applied by slide conditioning system.

8. The carrier of claim 7, wherein the bidirectional valve comprises a septum.

9. The carrier of claim 7, wherein the bidirectional valve is openable when engaging a fluid coupling port.

10. The carrier of claim 7, further comprising an agitation bar, disposed within the slide carrier and operable to agitate slides carried by the slide carrier.

11. The carrier of claim 10, wherein the agitation bar includes:
a lower member extending adjacent lower portions of slides carried by the slide carrier;
an extension member, extending upwardly from the lower member and out of the slide carrier; and
an engagement member, extending from the extension member;
wherein movement of the engagement member causes the lower member to agitate slides carried by the slide carrier.

12. A method of conditioning of a plurality of slides, comprising:
installing each of the plurality of slides into a slide carrier, the slide carrier having a bidirectional valve attached to or formed therein;
coupling the slide carrier to a rotor arm of a slide conditioning system;
engaging a fluid coupling port with the bidirectional valve of the slide carrier while the slide carrier is carried by the rotor arm; and
introducing fluid into the slide carrier through the fluid coupling port.

13. The method of claim 12, wherein installing each of the plurality of slides into the slide carrier includes installing each of the plurality of slides while the slide carrier is at least partially submerged in a liquid.

14. The method of claim 12, further comprising releasing fluid from the slide carrier through the fluid coupling port, disengaging the fluid coupling port from the bidirectional valve, and centrifuging the slide carrier.

15. The method of claim 14, further comprising adjusting a counterweight carried by the rotor arm according to a number of slides carried by the slide carrier.

16. The method of claim 14, further comprising re-engaging the bidirectional valve with the fluid coupling port and again introducing fluid into the slide carrier.

17. The method of claim 14, wherein releasing, disengaging and centrifuging are performed while the slide carrier remains attached to the rotor arm.

18. The method of claim 12, further comprising agitating the slides within the slide carrier to move the slides relative to the slide carrier.

19. The method of claim 18, wherein agitating includes actuating a portion of an agitation bar extending out of the slide carrier.
